(19) United States
(12) Patent Application Publication
(10) Pub. No.: US 2005/0029046 A1
(43) Pub. Date: Feb. 10, 2005

(54) Non-slip ladder apparatus and method

(76) Inventor: Martin L. Royce, Northfield, IL (US)

Correspondence Address: VEDDER PRICE KAUFMAN & KAMMHOLZ, 222 N. LASALLE STREET, CHICAGO, IL, 60601, US

(21) Appl. No.: 10/635,153

(22) Filed: Aug. 6, 2003

(51) Int. Cl. E06C 7/42

(52) U.S. Cl. 182/107; 182/129

(57) ABSTRACT

A ladder having top, bottom, first and second rails and a non-slip portion selectively attached to the ladder for preventing the ladder from slipping when disposed vertically against a wall or other elevated structure. A method of applying a non-stick surface is also disclosed.

### BACKGROUND OF THE INVENTION

1. Field of the Invention

The invention relates generally to an apparatus and method for introducing a non-slip attachment to ladders.

2. Description of Related Art

Ladders are used by a wide variety of people (“users”) for numerous applications. Users include those who use ladders on a daily basis, such as tradesman, skilled and unskilled laborers, as well as those who only use ladders sporadically, such as homeowners. Further, most commonly, ladders are made out of metal, wood and fiberglass, while other ladders are known to be composed of other materials. As typically designed, ladders have a bottom, top, two sets of outside support rails and a series of rungs serially spaced between the two support rails. A common use for ladders is to provide a means for scaling buildings. To scale a building, a user positions a ladder against a building such that the top of the ladder rests on the upper edge of the building and the base is located some distance away from the base of the building. Critical to the stability of the ladder is both the condition of the surface for which the base of the ladder is placed, and the condition of the upper edge of the building on which the upper portion of the ladder rests.

Unfortunately, the number of choices typically available for placing both the base of the ladder and the location for leaning the ladder against a building are often limited and are often less than optimal. For example, buildings are often known to contain functional or decorative treatments at their top edge including gutters, fascia, copings, or other such features. Such treatments are characterized by their low friction or otherwise relatively slippery surfaces. Such low friction surfaces are generally known to provide little resistance to the lateral shifting of the ladders resting thereon and thus are known to introduce increased physical dangers for those attempting to scale such buildings. To compensate for these greater dangers, ladder users are required to take extra precautions to reduce the chance that the ladder will shift laterally along the building. Such precautions are generally limited to the choosing of the best location to place the ladder, considering the best combination of base locations and building resting locations. Unfortunately, what may first appear to be an ideal surface for placing a base of the ladder, may only later, during actual use, be found to be problematic. Problem base surfaces often result in the unexpected shifting, sinking, or slipping of the base of the ladder, which, in turn, causes the portion of the ladder resting on the slippery low friction surface to shift or slide in a lateral direction across the building. Any such movement is undesirable and represents a threat to the physical well being of the ladder user. Further, the lack of adequate friction between the ladder and the building surface requires that the base of a ladder provide a large portion of the lateral stability of the ladder, as such, any problems with the base surface is amplified when the ladder rests upon a low friction surface on a building.

In an effort to reduce such dangers, and to reduce damage that occurs to building treatments by the resting of ladders thereupon, new ladder designs have been proposed. One proposal includes the use of load-dispersing bumpers on portions of ladder rails for resting against the top edge of the target buildings. This design includes the use of a bumper having a pair of flexible, resilient, load-dispersing bumpers, affixed to the ladder rails. The bumpers are described as being attached to the ladder by an external means. More specifically, the bumpers are described as being attached to the ladder by any one of the following: application of an external adhesive, double sided tape, hook and loop material, or multiple dome-topped pins dimensioned to fit within holes in the bearing surface. An alternative to this design includes using a strip of bumper material that is attached to the ladder by a large retaining clip. Another alternative design includes a bumper that is designed to clamp around the outside of the rail. Each of the above-described designs either require the use of an additional means to attach the bumpers to the ladder, or require the bumper itself to clamp onto a portion of the ladder. Other non-slip ladder solutions have been proposed, but such designs are generally limited to designs where the non-slip member is attached to the ladder at a location other than the surface of the side rails and/or otherwise attach such non-slip member in some type of clamping or rail-surrounding mechanism. In addition, many existing designs are applicable only to specific ladder designs and, therefore, cannot be used in conjunction with the standard ladders, thus, ignoring the safety threats presented by the vast majority of ladders in use today and which will continue to be used for years into the future.

As demonstrated above, a need exists for a simple, universal, non-slip, easy to apply, ladder attachment that provides lateral slip resistance between the ladder and the target building and that can be affixed to a wide variety of existing ladders. Desirably, the new attachment is capable of being easily installed by layman or persons otherwise without significant mechanical experience. Further, it would be desirable if the new attachment had the capability of being reapplied in response to an earlier applied attachment having experienced heavy wear and tear.

### BRIEF SUMMARY OF THE INVENTION

A method and apparatus attaching a non-slip tape portion to a rail of a ladder.

### BRIEF DESCRIPTION OF THE SEVERAL VIEWS OF THE DRAWINGS

FIG. 1 is a side elevational view of a ladder having non-slip tape attached to its upper portion and representing one embodiment of the invention;

FIG. 2 is a side perspective view of a ladder having non-slip tape attached to its upper portion and representing one embodiment of the invention;

FIG. 3 is a side elevational view of the non-slip tape extending along a linear path from one of the embodiments of the invention;

FIG. 4 is a side elevational view of the non-slip tape extending along a curved path from one of the embodiments of the invention;

FIG. 5 is a side elevational view of an extension ladder having non-slip tape attached to an upper portion of its upper extension and representing an embodiment of the invention;

FIG. 6 is a side perspective view of an extension ladder having non-slip tape attached to an upper portion of its upper extension and representing an embodiment of the invention;

FIG. 7 is a side elevational view of an extension ladder having non-slip tape attached to the upper portions of its upper and lower extensions and representing an embodiment of the invention; and

FIG. 8 is a side perspective view of an extension ladder having non-slip tape attached to the upper portions of its upper and lower extensions and representing an embodiment of the invention.

### DETAILED DESCRIPTION OF THE INVENTION

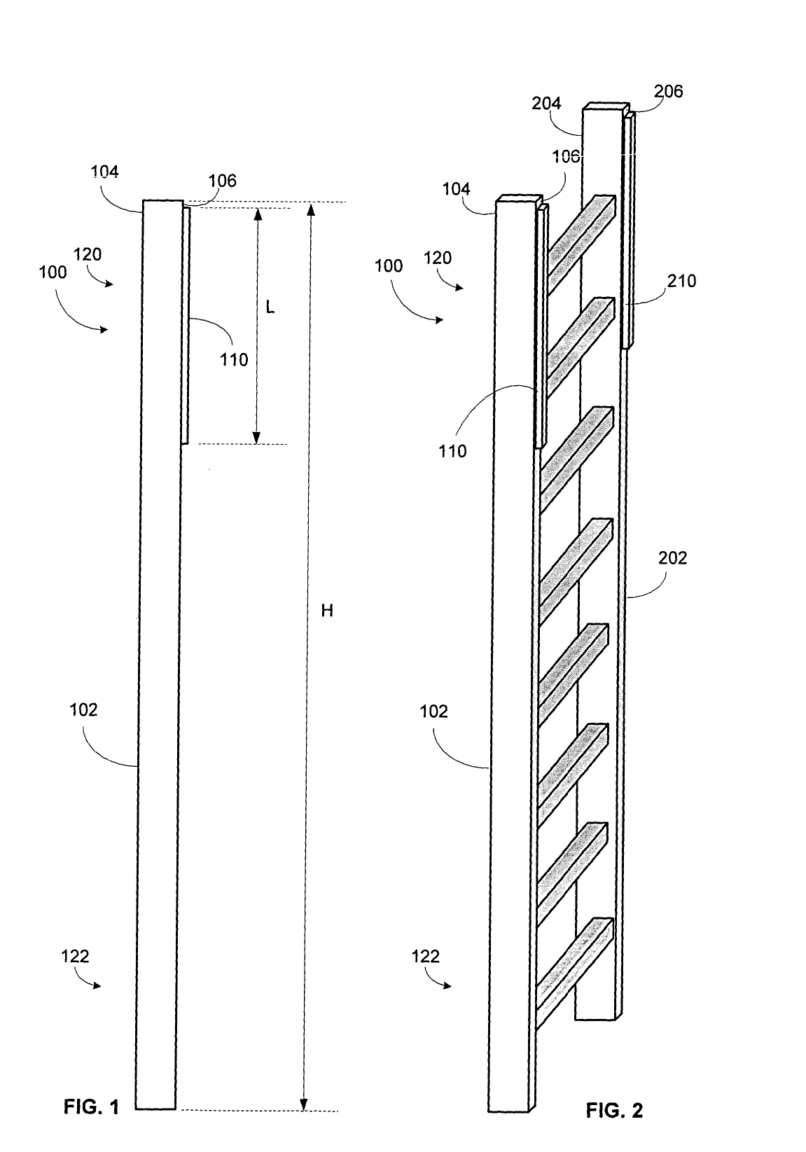

The embodiment shown in FIG. 1 includes a ladder 100 having a fixed height H, a top portion 120, a bottom portion 122, a first rail 102 having a first side 106 (building side) and a second side 104 (user side). Further attached to the first side 106 of the first rail 102 is a non-slip tape segment 110 having a length L. The non-slip tape segment 110 is located at a position along the first side 106 of first rail 102 such that when the ladder 100 is resting against a building, the ladder 100 rests against such building along its non-slip tape segment 110. Further, FIG. 2 shows the additional components, including a second rail 202 with a first side 206 and a second side 204. Attached to the first side 206 of the second rail 202 is a non-slip tape segment 210 having a similar length L to that of the corresponding non-slip tape segment 110. Although FIG. 2 indicates a second non-slip tape segment 210, other embodiments require only the first non-slip tape segment 110.

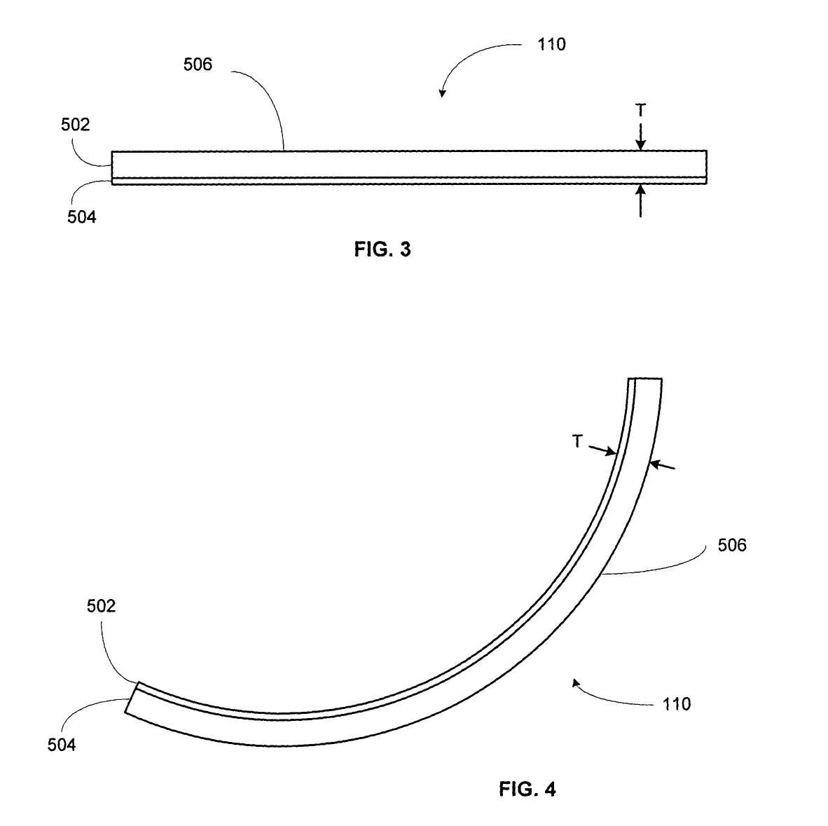

The non-slip tape segment 110 is further described in FIGS. 3 and 4. Further, the non-slip tape segments 210, 710, 810, 912 and 1012, described herein, if used, are known to have similar properties as those associated with the non-slip tape segment 110, although such properties may vary among the different non-slip tape segments 110, 210, 710 and 810 included on any one embodiment. The non-slip tape segment 110 has a thickness of T and is made up of a material side 502 (“material layer”) and an adhesive side 504 (“adhesive layer”). Further, the material side 502 has a non-slip outer surface 506. Because the non-slip tape segment 110 comes with an adhesive side or layer 504, i.e., the adhesive layer is pre-applied, no additional securing means outside of the tape itself is required to secure the non-slip tape segment 110 to the ladder 100. In one embodiment, the adhesive side 504 is originally covered by a tape cover or backing (not shown) which is peeled off before such non-slip tape segment 110 is applied to the first side 106. In another embodiment, the non-slip tape segment 110 is originally wound upon a tape roll as part of a larger accumulation of non-slip tape (not shown) such that the adhesive side 504 of one portion of the non-slip tape segment 110 adheres to the material side 502 of another portion of the non-slip tape segment 110. In one embodiment, the non-slip tape segment 110 is semi-rigid. In another embodiment, the non-slip tape segment 110 is pliable.

The non-slip tape segment 110 is located and/or applied to a location determined to represent that portion of the first side 106 of the first rail 102 such that when the ladder 100 is placed up against a target building, the non-slip tape segment 110 rests upon the edge of that building. More specifically, one particular method for applying the non-slip tape segment 110 to a ladder 100 includes the steps of identifying a building contact portion of the first rail 102 and applying the non-slip tape segment 110 to the building contact portion of the first rail. With the tape securely fastened to the first side 106 and with the ladder 100 leaning against the top edge of a building where the non-slip tape segment 110 is between the building edge and the first side 106, the non-slip outer surface 506 maintains a lateral frictional force with the building edge such that the non-slip tape segment 110 resists the ladder 100 from moving in a lateral direction along the building edge. As such, the ladder 100 tends to maintain its location on the top edge of the building in comparison to other ladders absent such non-slip structures that would tend to experience lateral movement under similar loads and forces. Further, a exemplary method for using the ladder 100 includes resting the ladder against a building, such that the anti-slip tape is located between the first side of the first rail of the ladder and the building, and then placing weight on a rung of the ladder 100, including a user stepping on the first rung and subsequently scaling a length of the ladder 100.

Although the embodiments shown in FIGS. 1 and 2 use a non-slip tape segment 110 having a thickness T of less than 1/16 of an inch, other embodiments use the non-slip tape segments 110 having a thickness T of greater than 1/16 of an inch. In one embodiment, the specific non-slip tape segment 110 is chosen from the 3M™, Safety-Walk™, Medium Resilient Tapes and Treads 300 Series known to have a dynamic coefficient of friction for a dry rubber surface of approximately 1.06, plus or minus 25%, and a static coefficient of friction of approximately 1.06, plus or minus 25%. In another embodiment, the specific non-slip tape segment 110 is chosen from the 3M™, Safety-Walk™, Fine Resilient Tapes and Treads 200 Series known to have a dynamic coefficient of friction for a dry rubber surface of approximately 1.29, plus or minus 25%, and a static coefficient of friction of approximately 1.38, plus or minus 25%. Another embodiment uses a non-slip tape segment 110 having foam rubber type qualities. Generally, although a number of embodiments use different types of non-slip tape segments 110, such embodiments each have a non-slip tape segment 110 that provides, when attached to a ladder 100, additional lateral friction between such first rail 102 and the building on which it leans, in comparison to those ladders without tape segment 110 attached thereto.

In one embodiment, the ladder 100 has a height H such that the first side 106 of the top portion 120 rests upon an upper edge of a building when placed there against. Further, the portion of the first side 106 that rests upon the building edge is that part of the first side 106 that is shown in FIG. 1 as being covered by the non-slip tape segment 110. In addition, and as shown in FIG. 2, the non-slip tape segment 210 is shown located on the second rail 202, and having substantially the same length as the non-slip tape segment 110, and located in substantially the same location along its corresponding second rail 202, such that when the ladder 100 is rested against the target building that its non-slip tape segment 210 on its first side 206, also rests upon the upper edge of the building. Although two non-slip tape segments 110 and 210 are shown attached to the ladder 100 in the embodiments shown in FIGS. 1 and 2, other embodiments use only a single non-slip tape segment 110 on one of the ladder 100 rails 102 and 202.

In operation, a ladder user would identify a target building that the ladder user wants to scale. Then, the ladder user would place the ladder 100 such that its bottom portion 122 would be located on a firm, flat, relatively non-slippery surface, and its top portion 120 would be rested against the top of such building where the non-slip tape segment 110 would be in contact with such top building edge. Once so placed, the user would ascend up the ladder, rung by rung, until the user reached their desired height. Throughout this procedure, and in contrast to standard ladders not having the non-slip tape segment 110 or other similar attachment, the non-slip tape segment 110 provides a gripping function that prevents the ladder 100 from moving in a lateral direction in comparison to the target building. As such, any conditions, (e.g., an unstable ladder footing, the shifting of weight moving up the ladder, etc.), that would otherwise urge a standard ladder to move laterally in relation to a building on which it rests, is countered to some degree by the non-slip tape segment 110 attached to the ladder 100.

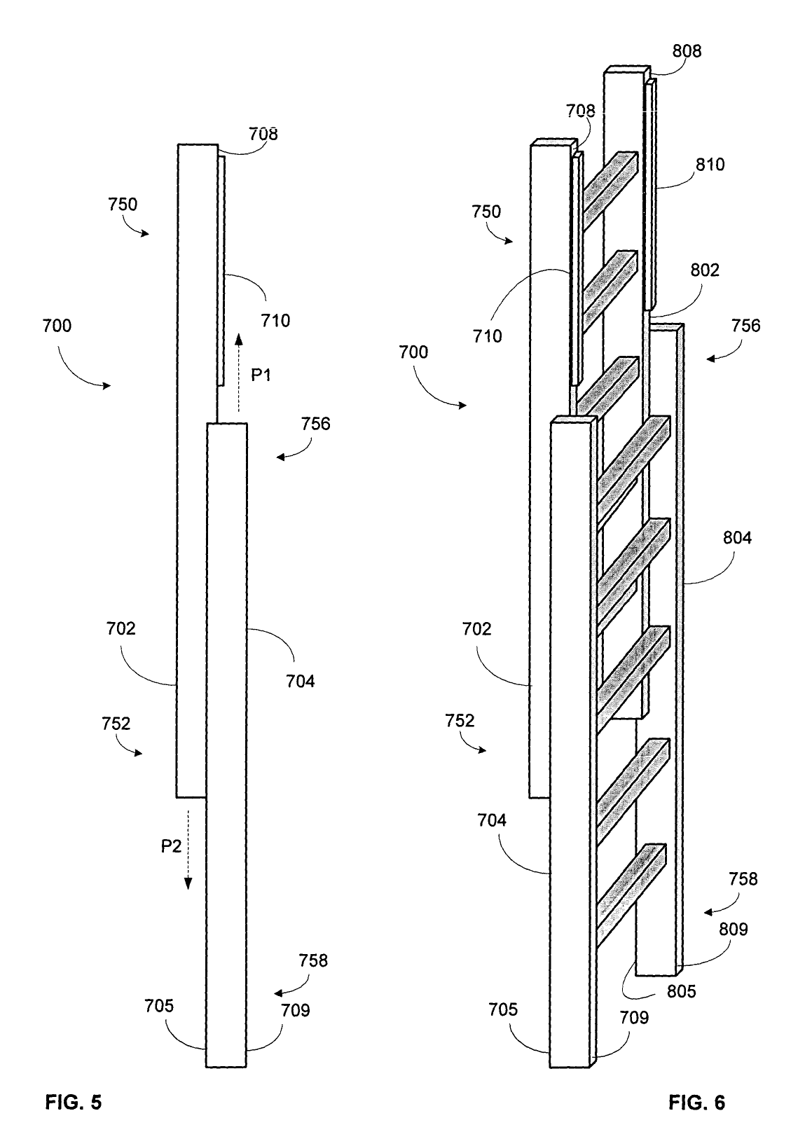

FIGS. 5-8 show embodiments that utilize an extendible ladder design. Here, rather than the simple two-rail design as shown in FIGS. 1-2, an inter-sliding four rail design is used. As shown in FIGS. 5 and 6, such extendable ladder 700 designs include a ladder having an upper first rail 702 and a lower first rail 704. Upper first rail 702 having upper and lower portions 750 and 752. Lower first rail 704 having upper and lower portions 756 and 758. The upper first rail 702 has a first side 708. The lower first rail 704 has a first side 709 and a second side 705. Further, attached to the first side 708 of the upper portion 750 of the upper first rail 702 is the non-slip tape segment 710. As with the other embodiments described above, such non-slip tape segment 710 is positioned to rest against a target building top edge. Further, as the upper first rail 702 moves in one direction P2 in relation to the lower first rail 704, and the lower first rail 704 moves in another direction P1 in relation to the upper first rail 704, the non-slip tape segment 710 does not prevent or impede the movement of such rails. Further, each of the paths followed by upper and lower first rails 702 and 704 in the respective directions P1 and P2 are parallel to one another.

FIG. 6 shows a perspective view that reveals additional components including upper second rail 802 and a lower second rail 804. The upper second rail 802 has a first side 808. The lower second rail 804 has a first side 809 and a second side 805. Upper second rail 802 having upper and lower portions 750 and 752. Lower first rail 804 having upper and lower portions 756 and 758. Further, attached to the first side 808 of the upper portion 750 of the upper first rail 802 is the non-slip tape segment 810. As with the other embodiments described above, such non-slip tape segment 810 is positioned to rest against a target building top edge. As the upper second rail 802 moves in relation to lower second rail 804, the non-slip tape segment 810 does not prevent or impede the movement of such rails, 802 and 804, in relation to one another.

Although embodiments utilizing an extendable ladder design have been described in correlation with FIGS. 5 and 6, and such embodiments have been described as using two pairs of sliding rails, other embodiments (not shown) that are extendable, use a plurality of pairs of sliding rails rather than just two, while yet other embodiments (not shown) use three or more rails associated with any particular rung rather than to two rails shown. In all such embodiments, at least one of the rails therein which is intended to rest on the edge of a building has located thereon a non-slip tape segment for providing the lateral stability described above.

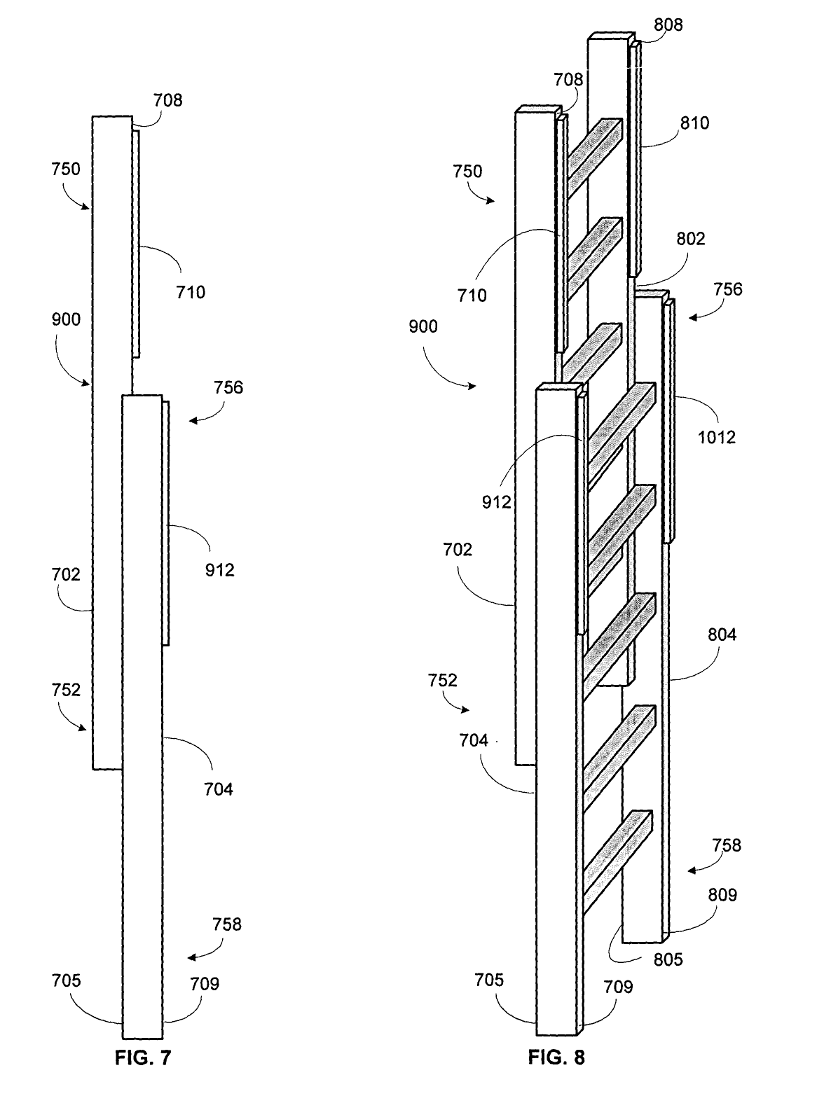

As shown in FIGS. 7 and 8, additional non-slip tape segments 912 and/or 1012 can be added to achieve a ladder 900 with additional non-slip tape segments 912 and 1012 attached to the upper portions 756 of rails 704 and 804 on their respective first sides 709 and 809.

In operation, a user operates the extendable ladders 700 and 900 similarly to that of single piece ladders 100. However, as extendable ladders, such ladders 700 and 900 operate like any standard extendable ladders, with the only exception being the placement of the non-slip tape segments located thereon and where such non-slip tape segments are meant to rest against the top edge of a target building. Further, ladder 900, having additional non-slip tape segments 912 and 1012 located near the upper portions 756 of rails 704 and 804, is further designed to be used on smaller buildings and structures where such non-slip tape segments 912 and 1012 can be used to rest against such target buildings and structures, rather than the non-slip tape segments 710 and 810, for example, where the upper first and second rails 702 and 802 are substantially retracted in relation to the lower first and second rails 704 and 804.

While only a few embodiments and aspects of the invention have been described above, including the preferred embodiment, those of ordinary skill in the art will recognize that these embodiments and aspects may be modified and altered without departing from the central spirit and scope of the invention. Thus, the embodiments and aspects described above are to be considered in all respects as illustrative and not restrictive, the scope of the invention being indicated by the appended claims, rather than by the foregoing description, and all changes which come within the meaning and range of equivalency of the claims are intended to be embraced herein.

1. (Canceled)

2. A ladder having top and bottom portions, first and second rails, the rails having a first side comprising:
non-slip tape attached to a rail; wherein the non-slip tape has an adhesive layer and a material layer; said non-slip tape having a thickness of between approximately 1/16 and ¼ inch.

3. The ladder of claim 2, wherein the adhesive layer is located between the material layer and the rail.

4. The ladder of claim 2, wherein the adhesive layer is pre-applied to the material layer.

5. The ladder of claim 2, wherein the material layer has a non-slip outer surface.

6. The ladder of claim 2, wherein the non-slip tape has a non-slip outer surface with a static coefficient of friction between and including 1.06 and 1.38, plus or minus 25%.

7. The ladder of claim 2, wherein the non-slip tape has a non-slip outer surface with a dynamic coefficient of friction between and including 1.06 and 1.29, plus or minus 25%.

8. The ladder of claim 2, wherein the non-slip tape has a thickness of less than 1/16 of an inch.

9. The ladder of claim 2, wherein the non-slip tape is attached to the first side of the first rail near the top portion of the ladder.

10. The ladder of claim 2, wherein the attached non-slip tape has a length of approximately 4 feet.

11. The ladder of claim 2, wherein the non-slip tape is further attached to the second rail.

12. The ladder of claim 2, having a upper and lower set of sliding rails wherein the upper and lower sets of sliding rails travel along parallel paths wherein a second side of the upper set of sliding rails faces the opposite direction of a first side of the lower set of sliding rails.

13. The ladder of claim 11, wherein the non-slip tape is located on the upper portion of the first side of the upper set of sliding rails.

14. The ladder of claim 13, wherein the non-slip tape does not hinder the parallel movement of the two sets of rails.

15. The ladder of claim 11, wherein the non-slip tape is located on the upper portion of the first side of the lower set of sliding rails.

16. (Canceled)

17. (Canceled)

18. (Canceled)

19. (Canceled)

20. (Canceled)
